(19) United States
(12) Patent Application Publication
(10) Pub. No.: US 2004/0088176 A1
(43) Pub. Date: May 6, 2004

(54) System and method of automated licensing of an appliance or an application

(76) Inventor: Balaji Rajamani, North Billerica, MA (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/286,764

(22) Filed: Nov. 4, 2002

(51) Int. Cl. G06F 17/60

(52) U.S. Cl. 705/1

(57) ABSTRACT

The invention is a system and method of automated licensing of an appliance or an application. The method includes obtaining for a customer a customer identification (23); obtaining for the customer the license entitlement (23′) for the appliance or the application; providing (56) from the customer to a licensing client associated with the appliance or the application the customer identification and the license entitlement; producing with the licensing client a validation key to identify an entity associated with the appliance or a host of the application; transmitting (58) the validation key, the customer identification and the license entitlement to a licensing server; processing (62) the validation key, the customer identification and license entitlement at the licensing server to determine if the validation key, the customer identification and license entitlement are verified, and generating (26) with the licensing server a license key.

### BACKGROUND OF THE INVENTION

1. Field of the Invention

The present invention relates to licensing of appliances or applications and more particularly, to automated licensing thereof.

2. Description of the Prior Art

FIG. 1 illustrates a manually operated prior art system and method 10 for providing licensing of appliances, such as network appliances or applications such as network management stations. The prior art system and method 10 is comprised of a customer 12 who licenses the appliance or application, a software license management infrastructure 14 and an appliance or application host 16 which includes a software licensing client 18. The customer may be either a person or an organization such as a business. The licensing performed by the system and method 10 is characterized by manual interaction between the customer 12, software license management infrastructure 14, and the network appliance and application host 16. These manual interactions include license registration of the appliance or application, which need the customer 12 manually interacting with the software license management infrastructure 14 and the network appliance or application host 16 to obtain a lookup appliance/application validation key 20 from the network appliance or application host 16 and forward the same along with the customer ID and the license entitlement 24 to the software license management infrastructure 14 which provides the license key 26 back to the customer 12. Earlier, the customer 12 would have registered himself with the software license management infrastructure 14, by forwarding the customer name and address 22 to it, upon which the software license management infrastructure 14 sends back the customer ID 23. The license entitlement 23′ is obtained by the customer 12 as part of the appliance or application sales/procurement process, which the customer uses in the appliance or application registration process. The license key 26 is generated by the software license management infrastructure verifying the customer ID, validation key and entitlement with stored counterparts thereof by comparison with the stored counterparts. After thus receiving the license key 26 from the license management infrastructure 14, the customer 12 manually installs the obtained license key 28 in the appliance or application host 16 which subsequently gets used by the software licensing client 18.

The prior art system and method of licensing 10 has the disadvantage of substantial customer interaction to complete the licensing process. The aforementioned customer interaction complicates the obtaining of the license and presents the possibility of potential error because of the numerous communications.

### SUMMARY OF THE INVENTION

The present invention improves the manual licensing process of the prior art of FIG. 1. In accordance with the invention, much less customer interaction with the software license management infrastructure is required than in the prior art by utilizing computer generated communications between the network appliance or application host and a software licensing server which are transparent to the customer. The dedicated licensing server, which is a subpart of the software license management infrastructure and the continuous connectivity between the licensing client and the licensing server of the invention facilitates automatic license renewal synchronization and continuous license updates under the control of the software licensing client of the appliance and application host. The license synchronization is achieved by the licensing client triggering the license synchronization process in a timed manner. This trigger can also occur during the daily verification of the license by the licensing client, if the verification process discovers that the license is expired or otherwise is invalid. The license synchronization process looks out for a license update or license renewal and updates the license automatically if one is available.

A method of automated licensing of an appliance or an application in accordance with the invention includes obtaining for a customer a customer identification; obtaining for the customer a license entitlement for a purchased appliance or a purchased application; providing from the customer to a licensing client associated with the appliance or the application the customer identification and the license entitlement; producing with the licensing client a validation key to identify an entity associated with the appliance or a host of the application; automatically transmitting the validation key, the customer identification and the license entitlement to a licensing server; processing the validation key, the customer identification and license entitlement at the licensing server to determine if the validation key, the customer identification and license entitlement are verified; and in response to determination that the validation key, the customer identification and the license entitlement are verified, generating with the licensing server a license key for the appliance or application which is transmitted by the licensing server to the licensing client which enables the appliance or application. A license of the appliance or the application which is contained in the license key may be updated continuously between the licensing server and the licensing client after initial generation and transfer of the license key. A source may provide the customer ID and the license entitlement to the customer and may provide the customer ID, the validation key associated with the appliance or application and the license entitlement of the appliance or application to the licensing server for storage therein before the verification of the validation key, the customer ID and license entitlement; and verification may be performed by the licensing server by comparing the validation key, the customer ID and license entitlement obtained from the source with the validation key, the customer ID and license entitlement received from the licensing client. The source may comprise a license management infrastructure. The validation key may be at least one of a serial number of the appliance or application, a medium access control address or an identification of a host of the application. The identification of the host of the application may be one of an email address, an IP address, a host computer machine name or a domain name of the customer. The medium access control address may be automatically detected by the licensing client of the appliance or application. The appliance may be a network appliance which performs a specified network function and may be a firewall. The application may be a program which is executed by a host of the application and may comprise a network management station. The licensing client may communicate with the licensing server and determine if a license for the appliance or application exists, and if the license exists, may fetch the license and install the license in the appliance or a host of the application. The licensing client may determine a duration of the license for the appliance or application and may determine if the license is valid. The licensing client may communicate with the licensing server periodically to obtain any license updates to the license of the appliance or application. The licensing client may communicate with the licensing server to update the appliance or a host of the application with a time of day to determine if the time is synchronized in accordance with the licensing server.

A system for providing automated licensing of an appliance or an application in accordance with the invention includes a licensing client associated with the appliance or the application; and a licensing server; and wherein a customer identification is obtained for a customer, a license entitlement for a purchased appliance or a purchased application is obtained for the customer, providing from the customer to the licensing client associated with the appliance or the application the customer identification and the license entitlement, producing with the licensing client a validation key to identify an entity associated with the appliance or a host of the application, automatically transmitting the validation key, the customer identification and the license entitlement to the licensing server, processing the validation key, the customer identification and license entitlement at the licensing server to determine if the validation key, the customer identification and license entitlement are verified, and in response to determination that the validation key, the customer identification and the license entitlement are verified, generating with the licensing server a license key for the appliance or application which is transmitted by the licensing server to the licensing client which enables the appliance or application. A license of the appliance or the application which is contained in the license key may be updated continuously between the licensing server and the licensing client after initial generation and transfer of the license key. A source may provide the customer ID and the license entitlement to the customer and may provide the customer ID, the validation key associated with the appliance or application and the license entitlement of the appliance or application to the licensing server for storage therein before the verification of the validation key, the customer ID and license entitlement; and verification may be performed by the licensing server by comparing the validation key, the customer ID and license entitlement obtained from the source with the validation key, the customer ID and license entitlement received from the licensing client. The source may comprise a license management infrastructure. The validation key may be at least one of a serial number of the appliance or application, a medium access control address or an identification of a host of the application. The identification of the host of the application may be one of an email address, an IP address, a host computer machine name, or a domain name of the customer. The medium access control address may be automatically detected by the licensing client of the appliance or application. The appliance may be a network appliance which performs a specified network function and may be a firewall. An application may be a program which is executed by a host of the application and may comprise a network management station. The licensing client may communicate with the licensing server and determine if a license for the appliance or application exists, and if the license exists, may fetch the license and install the license in the appliance or a host of the application. The licensing client may determine a duration of the license for the appliance or application and may determine if the license is valid. The licensing client may communicate with the licensing server periodically to obtain any license updates to the license of the appliance or application. The licensing client may communicate with the licensing server to update the appliance or a host of the application with a time of day to determine if the time is synchronized in accordance with the licensing server.

### BRIEF DESCRIPTION OF THE DRAWINGS

FIG. 1 illustrates a diagram of the prior art.

FIG. 2 illustrates a diagram of the system and process of automated licensing of an appliance or an application in accordance with the present invention.

FIG. 3 illustrates a block diagram of a timed license verification thread which is a module resident in the software licensing client of the present invention.

FIG. 4 illustrates a license registration and issue thread which is made of modules resident in the software licensing client and the licensing server of the present invention.

FIG. 5 illustrates a triggered license synchronization thread which is made of modules which are resident in the software licensing client and the licensing server of the present invention.

Like reference numerals identify like parts throughout the drawings.

### DETAILED DESCRIPTION OF THE PREFERRED EMBODIMENT OF THE INVENTION

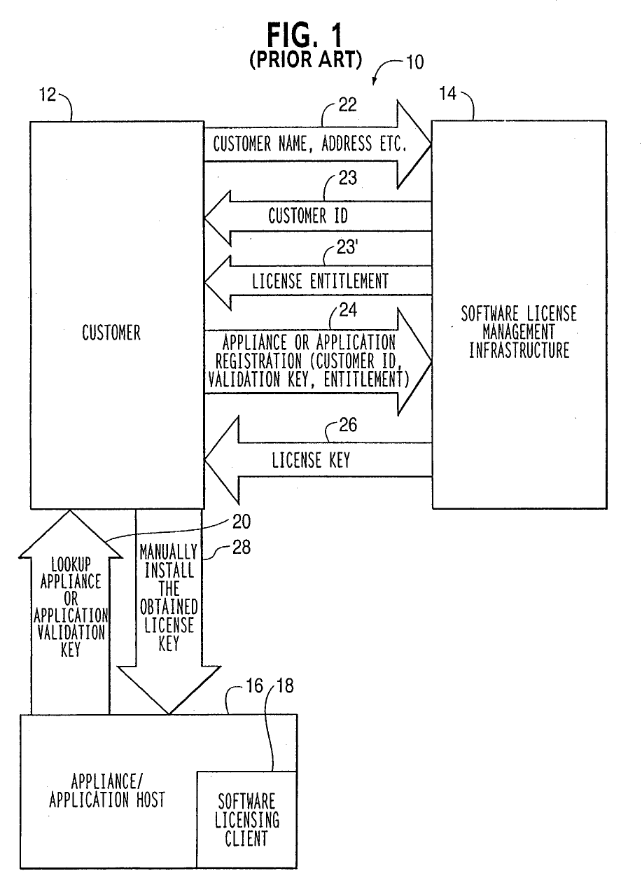

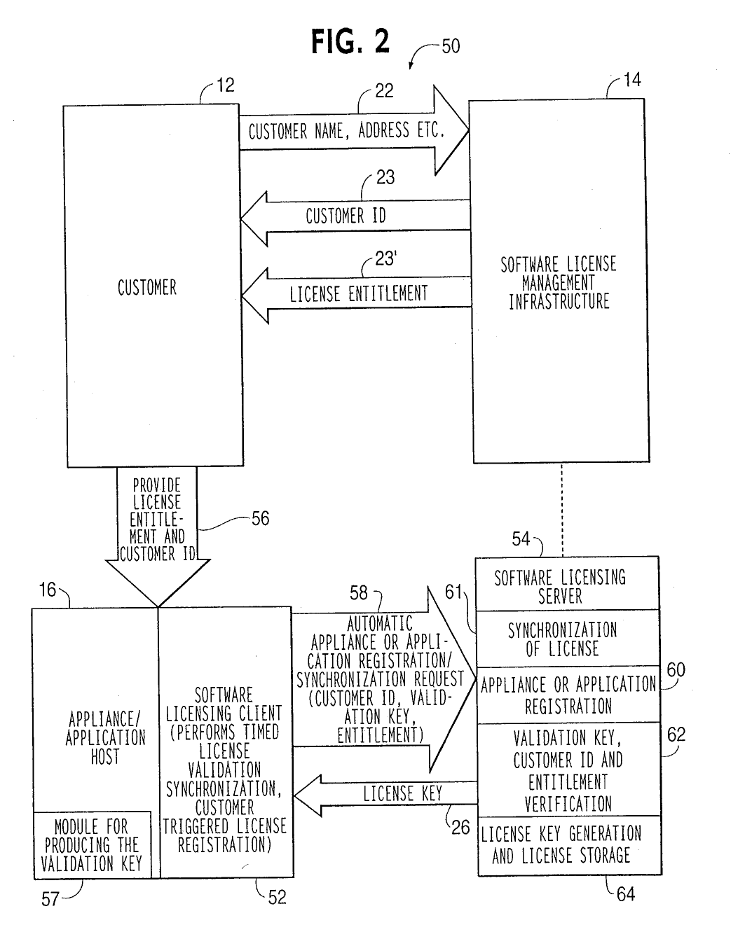

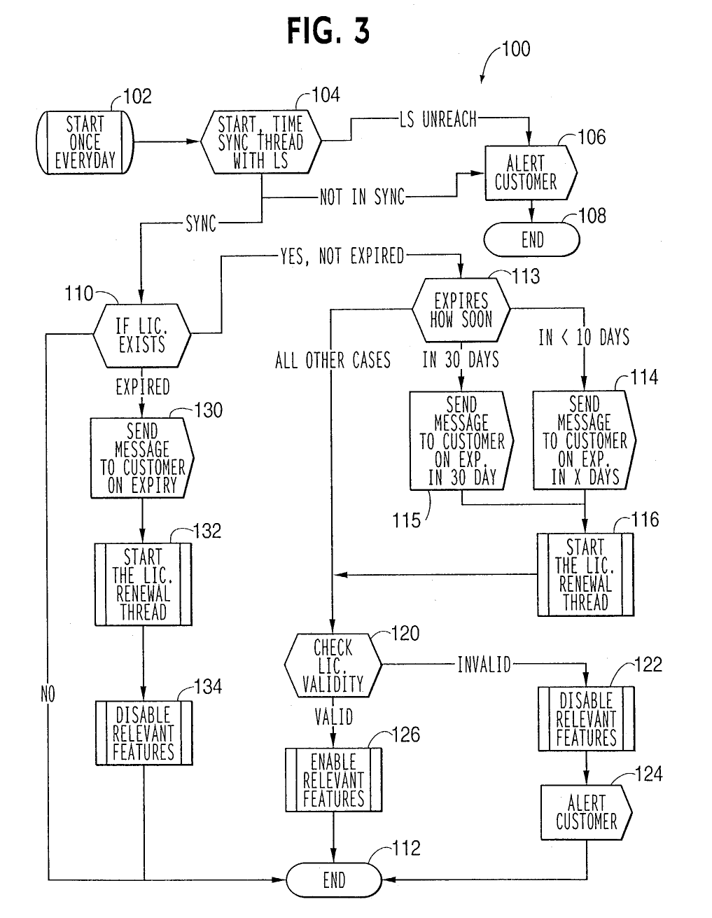

FIG. 2 illustrates a system and method 50 in accordance with the present invention. The system and method 50 differs from the prior art of FIG. 1 by providing a method and system for licensing an appliance or an application which requires substantially less intervention by the customer 12 and further provides additional and enhanced licensing capabilities which are not possible with the prior art. The software licensing client 52, as described below in conjunction with FIGS. 3-5, provides updated verification, license registration, license renewal and updating of the license.

The operation of the system and process 50 of FIG. 2 is as follows. Initially, the customer 12 provides the customer name and address 22 to the software licensing management infrastructure 14 and receives the customer ID 23. The customer also receives a license entitlement 23′ from the software license management infrastructure 14, as part of the purchase of the product, which in this case will be an appliance or application. The above steps are similar to those in the prior art. Thereafter, the customer 12 provides the license entitlement and the customer ID 56 to the appliance or application host 16. The module 57 produces the validation key which may be without limitation at least one of a serial number of the appliance or application, a medium access control address (MAC) or an identification of a host of the application. Validation keys, such as the serial number, the customer email address, or domain name, are provided by the customer. Validation keys, such as a medium control address and IP address are system parameters which are looked up by the system. The software licensing client 52 communicates with the software licensing server 54 to perform automatic appliance registration 58 which includes the transmission of the customer ID, the validation key and the entitlement. As indicated by the dotted line connecting the software license management infrastructure 14 and the software licensing server, the software licensing server 54 is associated with the software license management infrastructure 14. The software license management infrastructure 14 is an abstract entity which may be comprised of sales personnel, a legal department, an inventory department, and any sales and licensing policy bodies in addition to various tools at their disposal. These tools may include hardware and software components which satisfy the overall needs of the software license management infrastructure 14. One such tool is the licensing server 54. The software licensing server 54 performs appliance or application registration 60, the subsequent license synchronization 61, and verification of the validation key, customer ID and entitlement 62 by comparing the customer ID, validation key and entitlement 58 with previously stored information provided from the software license management infrastructure 14. Thereafter, the software licensing server 54 performs license key generation and license storage 64 which results in the license key 26 being automatically transmitted to the software licensing client 52 without manual intervention as required in the prior art.

As may be seen from the foregoing description, the customer 12 is required to provide only the customer name and address 22 to the software licensing management infrastructure 14 in response to which the customer obtains the customer ID 23. The license entitlement 23′ and customer ID 23 are passed as customer input 56 to the software licensing client 52. The software licensing client 52 thereafter provides automatic appliance or application registration, including the subsequent license synchronizations, process 58. Additionally, the software licensing client 52 installs the license in the appliance or a host of the application. The module 57 produces the validation key which is transmitted as part of the automatic appliance or application registration process 58.

The appliance in a preferred embodiment may be a network appliance. Network appliances may be defined as appliances that perform specified network functions such as a firewall.

The validation key, may be an identification of a host of the application. The validation key may be without limitation the MAC address, the serial number of the network appliance or a host of the application, an email address, an IP address or a domain name of the customer.

The application, which is executed by a host of the application may be without limitation a network management station.

In addition to the foregoing description, the functions performed by the software licensing client 52 and the software licensing server 54, comprising the timed license validation, synchronization, and user triggered license registration may be described in detail as follows, in conjunction with FIGS. 3-5.

FIG. 3 illustrates a timed license verification thread 100 which is performed by the software licensing client 52. The timed license verification thread 100 performs significant actions, such as synchronizing the time with the licensing server 54. The timed license verification thread 100 has intelligence to automatically trigger fetching the renewed license or license updates, if an expired or invalid license is discovered. The timed license verification thread 100 starts at point 102 which occurs once a day. Processing proceeds from point 102 to starting of synchronization of the time with the licensing server 54 (LS). If the licensing server 54 is unreachable, processing proceeds to point 106 where an alert to the customer is provided. Thereafter, the processing ends at point 108. If the time is not in synchronization with the LS at 104, processing proceeds to alerting of the customer at point 106 as described above. However, if the time of the thread is in synchronization with the LS at point 104, processing proceeds to point 110 where a determination is made if a license exists. If the answer is “no” at point 110, processing proceeds to endpoint 112. If a determination is made at point 110 that a license has not expired, processing proceeds to point 113 where a determination is made of how soon the license will expire. If the license expires in less than ten days, processing proceeds from point 113 to point 114 where a message is sent to the customer that expiration will occur in a number of days. If a determination at point 113 is made that the license expires in thirty days, processing proceeds to point 115 where a message is sent to the customer that the license will expire in thirty days. Processing proceeds from point 114 or point 115 to point 116 where starting of the license synchronization thread occurs due to the imminent license expiry, to seek any renewed or updated licenses. Processing proceeds from point 116 to point 120 where a determination is made if the license is valid. For all other determinations made at point 113, processing proceeds to the checking of the license validity at point 120 as described above. If the license is determined to be invalid at point 120, processing proceeds to procedures for an invalid license including disabling of relevant features at point 122, followed by alerting customer at point 124 followed by ending at end 112. Relevant features are dependent on the licensing scheme for a particular product and can be considered to be a key software component which enables or disables the value of the appliance or application. For example, if one needs to control a firewall appliance with a license, the module to be enabled or disabled by the software license client 52 would be the IPSEC (Internet Protocol Security Protocol) module. If the license is determined at point 120 to be valid, processing proceeds to point 126 where relevant features of the license are enabled followed by proceeding to endpoint 112. The relevant features are as described above. If at point 110 the license is determined to be expired, a message is sent to the customer at point 130 that expiration has occurred. Processing proceeds from point 130 to point 132 to start the license synchronization thread followed by disabling of relevant features at point 134, and finally proceeding to endpoint 112. The relevant features are as described above.

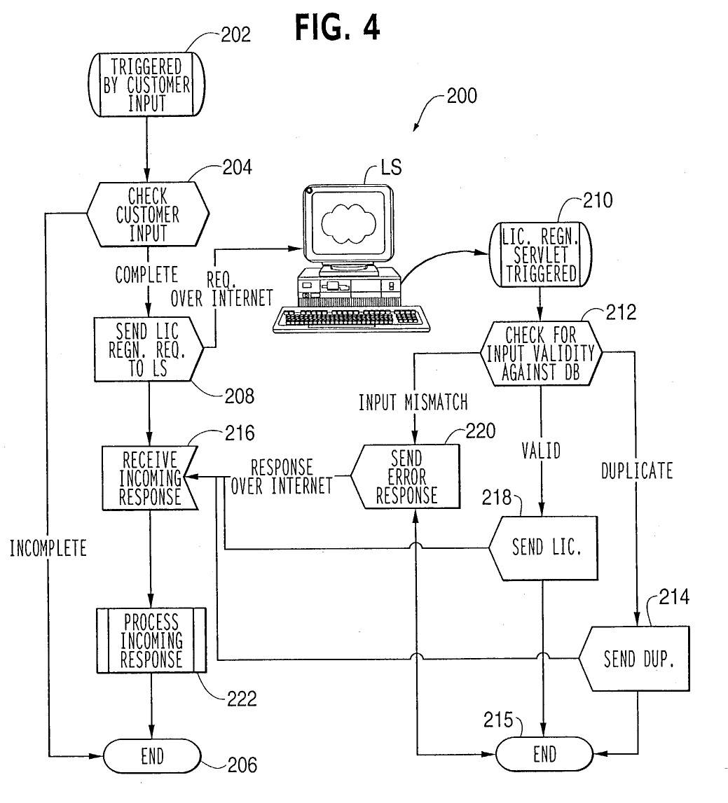

FIG. 4 illustrates the license registration and issue functionality performed by the license registration thread 200 in the licensing client 52, in consonance with the license registration component of the software licensing server 54. The thread 200 is an important module in the software licensing client 52 and supports automation of the licensing scheme. The thread 200 obtains the customer ID and license entitlement input from the customer and from then on transparently sends the information along with the validation key to the software licensing server 54, receives the response from the software licensing server and installs the incoming license, if a valid license is received from the server. The license registration and issue component of the licensing server verifies the incoming client information, and if valid, generates the license and sends it across to the software licensing client 52. Processing of thread 200 starts at point 202 representing a trigger associated with customer input. Processing proceeds to point 204, where a check is made if there is a customer input. If the customer input is incomplete, processing proceeds from point 204 to endpoint 206. The thread 200 may be initiated again by another customer input which must be complete for the thread to run to completion. On the other hand, if the checking of the customer input at point 204 indicates a complete input, processing proceeds to point 208 where a licensing registration request is sent to the licensing server 54 (LS) over the internet. The receipt of this request by the licensing server LS at point 210 causes a licensing registration servlet 60 to be triggered. Processing proceeds from point 210 to point 212 where a verification operation is performed of checking the validity of the input against a database in order to determine is the license registration request is valid. If the answer is that the license registration request is determined to be a duplicate, processing proceeds to point 214 where a communication signalling that the license registration request is a duplicate is sent to reception point 216 which is an indication of the license client waiting for the license registration response to the request it initiated at point 208. Thereafter the server processing proceeds to endpoint 215. If the check at point 212 determines that the licensing registration request is valid, processing proceeds to point 218 where a license is sent to point 216 and processing proceeds to endpoint 215. If the checking of the input validity against the database at point 212 determines that there is a mismatch between the license registration request and the database, processing proceeds to point 220 where an error response is sent to the reception point 216, and processing proceeds to endpoint 215. After receiving the incoming response at point 216, the client processing proceeds to the actual processing of the incoming response at point 222, which comprises checking the license validity and if valid enabling the relevant features, followed by the endpoint 206. The relevant features are the same as in the discussions above.

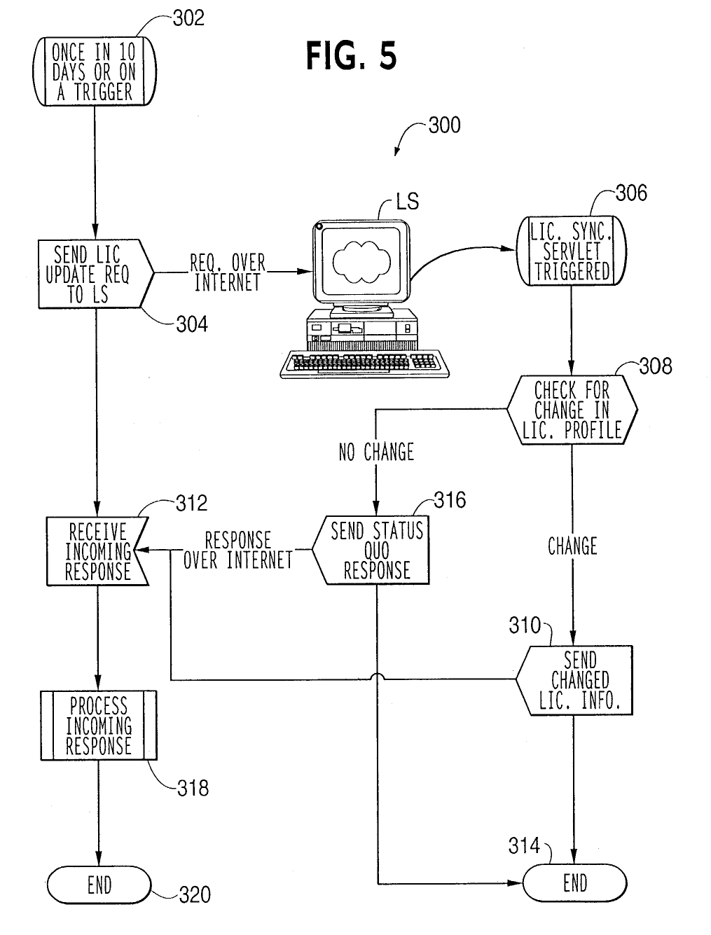

FIG. 5 illustrates the triggered license synchronization thread 300 performed by the software licensing client 52, in consonance with the license synchronization component of the licensing server 54. The license synchronization thread 300 facilitates the automated licensing provided by the present invention. The thread 300 adds value by rendering the software licensing client 52 up to date with the license at the software licensing server 54 which provides flexibility to effect policy changes to the license at the licensing server based either on the license renewal information or on any licensing policy changes. A license thus changed at the licensing server 54 automatically propagates to the licensing client 52 by means of this mechanism. The software licensing client 52 initiates the process by starting the license synchronization thread 300 either on a periodic basis or on discovery of an expired or invalid license. The triggered license synchronization thread 300 starts at point 302 where a communication is initiated once in, for example, a system selectable time, such as ten days or in response to a license validity check. Processing proceeds from point 302 to point 304 where a license update request is sent to the licensing server 54 (LS). The receipt of this request by the licensing server LS at point 306 causes a license synchronization servlet 61 to be triggered. Processing proceeds to point 308 where a check for change in the license profile is made. A change in license profile includes license renewals or other changes to the license resultant from changes in the licensing policy dictated by the software license management infrastructure 14. For instance, the changes can be due to extending the license duration as part of rewarding a customer buying more units. If there is a change in the license profile determined at point 308, processing proceeds to point 310 where the changed license information is transmitted to reception point 312, which is an indication of the licensing client waiting for the license synchronization response to the request it initiated at point 304, and processing proceeds to endpoint 314. If the checking for a change in the licensing profile 308 indicates no change, processing proceeds to point 316 where a status quo response is sent to the reception point 312, and processing proceeds to endpoint 314. The client processing proceeds from the reception point 312 to processing of the incoming response at point 318, which comprises checking the license validity and if valid, enabling the relevant features, followed by proceeding to endpoint 320. The relevant features the same as explained above.

While the invention has been described in terms of its preferred embodiments, it should be understood that numerous modifications may be made thereto without departing from the spirit and scope of the present invention. It is intended that all such modifications fall within the scope of the appended claims.

1. A method of automated licensing of an appliance or an application comprising:
obtaining for a customer, a customer identification;
obtaining for a customer a license entitlement for a purchased appliance or a purchased application;
providing from the customer to a licensing client associated with the appliance or the application the customer identification and the license entitlement;
producing with the licensing client a validation key to identify an entity associated with the appliance or a host of the application;
transmitting the validation key, the customer identification and the license entitlement from the licensing client to a licensing server;
processing the validation key, the customer identification and license entitlement at the licensing server to determine if the validation key, the customer identification and license entitlement are verified; and
in response to determination that the validation key, the customer identification and the license entitlement are verified, generating with the licensing server a license key for the appliance or application which is transmitted by the licensing server back to the licensing client which enables the appliance or application.

2 A method in accordance with claim 1 wherein:
a license of the appliance or the application which is contained in the license key is updated continuously between the licensing server and the licensing client after initial generation and transfer of the license key.

3. A method in accordance with claim 1, comprising:
a source providing the customer ID and the license entitlement to the customer and providing the customer ID, the validation key associated with the appliance or application and the license entitlement of the appliance or application to the licensing server for storage therein before the verification of the validation key, the customer ID and license entitlement; and
verification is performed by the licensing server by comparing the validation key, the customer ID and license entitlement obtained from the source with the validation key, the customer ID and license entitlement received from the licensing client.

4. A method in accordance with claim 3 wherein:
the source comprises a license management infrastructure.

5. A method in accordance with claim 1, wherein the validation key comprises:
at least one of a serial number of the appliance or application, a medium access control address, an IP address, or an identification of a host of the application.

6. A method in accordance with claim 5, wherein:
the identification of the host of the application is one of an email address, a host computer machine name, or a domain name of the customer.

7. A method in accordance with claim 5, wherein:
the medium access control address is automatically detected by the licensing client of the appliance or application.

8. A method in accordance with claim 1, wherein the appliance comprises:
a network appliance which performs a specified network function.

9. A method in accordance with claim 8, wherein the network appliance comprises:
a firewall.

10. A method in accordance with claim 1, wherein the application comprises:
a program which is executed by a host of the application.

11. A method in accordance with claim 10, wherein:
the program comprises a network management station.

12. A method in accordance with claim 1, wherein:
the licensing client communicates with the licensing server and determines if a license for the appliance or application exists, and if the license exists, fetches the license and installs the license in the appliance or a host of the application.

13. A method in accordance with claim 12, wherein:
the licensing client determines a duration of the license for the appliance or application and whether the license is valid.

14. A method in accordance with claim 2, wherein:
the licensing client communicates with the licensing server periodically to obtain any license updates to the license of the appliance or application.

15. A method in accordance with claim 1, wherein:
the licensing client communicates with the licensing server to update the appliance or a host of the application with a time of day to verify if the time is synchronized in accordance with the licensing server.

16. A system for providing automated licensing of an appliance or an application comprising:
a licensing client associated with the appliance or the application; and
a licensing server; and wherein
a customer identification and a license entitlement for the appliance or the application is obtained for a customer, providing from the customer to the licensing client associated with a purchased appliance or a purchased application the customer identification and the license entitlement, producing with the licensing client a validation key to identify an entity associated with the appliance or a host of the application, transmitting the validation key, the customer identification and the license entitlement to the licensing server, processing the validation key, the customer identification and license entitlement at the licensing server to determine if the validation key, the customer identification and license entitlement are verified, and in response to determination that the validation key, the customer identification and the license entitlement are verified, generating with the licensing server a license key for the appliance or application which is transmitted by the licensing server to the licensing client which enables the appliance or application.

17. A system in accordance with claim 16 wherein:
a license of the appliance or the application which is contained in the license key is updated continuously between the licensing server and the licensing client after initial generation and transfer of the license key.

18. A system in accordance with claim 16, comprising:
a source providing the customer ID and the license entitlement to the customer and providing the customer ID, the validation key associated with the appliance or application and the license entitlement of the appliance or application to the licensing server for storage therein before the validation of the validation key, the customer ID and license entitlement; and
verification is performed by the licensing server by comparing the validation key, the customer ID and license entitlement obtained from the source with the validation key, the customer ID and license entitlement received from the licensing client.

19. A system in accordance with claim 18 wherein:
the source comprises a license management infrastructure.

20. A system in accordance with claim 16, wherein the validation key comprises:
at least one of a serial number of the appliance or application, a medium access control address, an IP address, or an identification of a host of the application.

21. A system in accordance with claim 20, wherein:
the identification of the host of the application is one of an email address, a host computer machine name, or a domain name of the customer.

22. A system in accordance with claim 20, wherein:
the medium access control address is automatically detected by the licensing client of the appliance or application.

23. A system in accordance with claim 16, wherein the appliance comprises:
a network appliance which performs a specified network function.

24. A system in accordance with claim 23, wherein the network appliance comprises:
a firewall.

25. A system in accordance with claim 16, wherein the application comprises:
a program which is executed by a host of the application.

26. A system in accordance with claim 25, wherein:
the program comprises a network management station.

27. A system in accordance with claim 16, wherein:
the licensing client communicates with the licensing server and determines if a license for the appliance or application exists, and if the license exists, fetches the license and installs the license in the appliance or a host of the application.

28. A system in accordance with claim 27, wherein:
the licensing client determines a duration of the license for the appliance or application and whether the license is valid.

29. A system in accordance with claim 17, wherein:
the licensing client communicates with the licensing server periodically to obtain any license updates to the license of the appliance or application.

30. A system in accordance with claim 16, wherein:
the licensing client communicates with the licensing server to update the appliance or a host of the application with a time of day to verify if the time is synchronized in accordance with the licensing server.
